(19) United States
(12) Patent Application Publication
(10) Pub. No.: US 2011/0279752 A1
(43) Pub. Date: Nov. 17, 2011

(54) OPTICAL FILM AND LIQUID CRYSTAL DISPLAY DEVICE COMPRISING SAME

(75) Inventors: Motohiro Yamahara, Nara (JP); Yasuhiro Haba, Ehime (JP); Tomonori Miyamoto, Osaka (JP)

(73) Assignee: SUMITOMO CHEMICAL COMPANY, LIMITED, Chuo-ku, Tokyo (JP)

(21) Appl. No.: 13/141,273

(22) PCT Filed: Dec. 18, 2009
(86) PCT No.: PCT/JP2009/071127

§ 371 Date: Aug. 4, 2011

(30) Foreign Application Priority Data
Dec. 23, 2008 (JP) 2008-326665

(51) Int. Cl. G02F 1/13357; G02B 5/02; G02F 1/1335

(52) U.S. Cl. 349/64; 349/61; 359/599

(57) ABSTRACT

The present invention provides an optical film which is capable of impeding the occurrence of a failure of display quality at wide view angles, impeding the occurrence of the degradation of the front contrast, achieving a high transmission image definition, and impeding the occurrence of scintillation, and a liquid crystal display device comprising the same. On a substrate film 71, an anti-glare layer 72 in which translucent fine particles 722 are dispersed and mixed in a translucent resin 721 is laminated. The average particle size of the translucent fine particles 722 is set at 0.5 μm or more and less than 5 μm, and the content of the translucent fine particles 722 is set at 35 parts by weight or more and 60 parts by weight or less in relation to 100 parts by weight of the translucent resin. The layer thickness of the anti-glare layer 72 is set at one or more and three or less times the average particle size of the translucent fine particles 722. It is preferable to make the refractive index of the translucent fine particles 722 larger than the refractive index of the translucent resin 721, and the difference between the refractive index of the translucent fine particles 722 and the refractive index of the translucent resin 721 is preferably 0.04 or more and 0.1 or less.

### TECHNICAL FIELD

The present invention relates to an optical film and a liquid crystal display device comprising the same.

### BACKGROUND ART

Recently, in display devices such as liquid crystal display devices, with the increase of the size of the display screen, sometimes it has been experienced that light enters externally on the display screen, and this light is reflected and disturb the viewing of the display screen image. Accordingly, by providing an anti-glare film on the display screen side of the displays to diffuse such light, the mirroring of the reflected image due to the surface reflection has been suppressed.

As such an anti-glare film, there has hitherto been proposed an anti-glare film prepared by coating a transparent substrate film with a resin in which resin beads are mixed and dispersed, so as to form asperities on the surface of the film (Patent Literature 1). By providing this anti-glare film on the display surface of the display, the external incident light is scattered due to the surface asperities formed by the resin beads and due to the refractive index difference between the resin and the resin bead, and thus the mirroring of the reflected image on the surface of the display is reduced.

### CITATION LIST

### Patent Literature

Patent Literature 1: Japanese Patent Application Laid-Open Publication No. 6-18706

### SUMMARY OF INVENTION

### Technical Problem

In such an anti-glare film as described above, for the purpose of suppressing scintillation, it is necessary to increase the haze value to a certain degree. However, when the haze value of the anti-glare film is large, there may occur a problem that the front contrast (the ratio of the front luminance in the white display mode to the front luminance in the black display mode) and the transmission image definition are degraded. Under such circumstances, for liquid crystal display devices, there is demanded an optical film which is capable of impeding the occurrence of a failure of display quality at wide view angles, enhancing the front contrast and the transmission image definition, and impeding the occurrence of scintillation.

### Solution to Problem

An optical film of the present invention achieving the above-described object comprises a substrate film and an anti-glare layer in which translucent fine particles are dispersed and mixed in a translucent resin, wherein the average particle size of the translucent fine particles is 0.5 μm or more and less than 5 μm, a content of the translucent fine particles is 35 parts by weight or more and 60 parts by weight or less in relation to 100 parts by weight of the translucent resin, and a layer thickness of the anti-glare layer is one or more and three or less times the average particle size of the translucent fine particles.

In the present invention, the average particle size of the translucent fine particles is the size at the 50% by weight in the particle size distribution based on the Coulter principle (a pore electric resistance method) and can be determined with the Coulter Multisizer (manufactured by Beckman Coulter, Inc.).

It is preferable that a refractive index of the translucent fine particles is larger than a refractive index of the translucent resin, and it is preferable that a difference between the refractive index of the translucent fine particles and the refractive index of the translucent resin is 0.04 or more and 0.1 or less.

The liquid crystal display device of the present invention is a liquid crystal display device, comprising, in sequence, a backlight device, a light deflecting means, a first polarizing plate, a liquid crystal cell having a liquid crystal layer provided between a pair of substrates, a second polarizing plate, and an optical film, wherein the first polarizing plate and the second polarizing plate are arranged such that transmission axes thereof are in crossed Nicol relation, and as the optical film, any of the above-described optical films is used.

From the viewpoint of obtaining an excellent front direction luminance, it is preferable to use two sheets of the prism films provided on a light exiting surface with a plurality of linear prisms having a polygonal and tapered cross-section and an endmost vertex angle of 90 to 110° at predetermined intervals, as the light deflecting means, and to arrange one of the prism films such that ridge line directions of the linear prisms thereof are approximately parallel to the transmission axis of the first polarizing plate and arrange the other prism film such that ridge line directions of the linear prisms thereof are approximately parallel to the transmission axis of the second polarizing plate. It is to be noted that, in present Description, the phrase, approximately parallel, means that the case of being perfectly parallel and the cases of deviating within an angle range of about ±5° from being parallel are included.

It is preferable to further arrange a light diffusing means between the backlight device and the light deflecting means.

### Advantageous Effects of Invention

In the liquid crystal display device comprising the optical film of the present invention, the occurrence of a failure of display quality at wide view angles is impeded, a high front contrast and a high transmission image definition are obtained, and the occurrence of scintillation is also impeded.

### BRIEF DESCRIPTION OF DRAWINGS

FIG. 1 is a schematic diagram illustrating an example of the optical film according to the present invention.

FIG. 2 shows schematic diagrams illustrating other examples of the optical film according to the present invention.

FIG. 3 is a schematic diagram of an example of the polarizing plate using the optical film of the present invention.

FIG. 4 is a schematic diagram illustrating an example of the liquid crystal display device according to the present invention.

FIG. 5 is a schematic diagram illustrating an example of the arrangement of the prism films and the polarizing plates.

FIG. 6 is a schematic diagram illustrating another example of the liquid crystal display device according to the present invention.

FIG. 7(a) is a front view of the liquid crystal display device according to the present invention, and FIG. 7(b) is a view of the plane 14b of FIG. 7(a) as viewed from the direction perpendicular to the plane 14b.

### DESCRIPTION OF EMBODIMENTS

Hereinafter, the optical film and the liquid crystal display device according to the present invention are described on the basis of the drawings; however, the present invention is not limited to these embodiments.

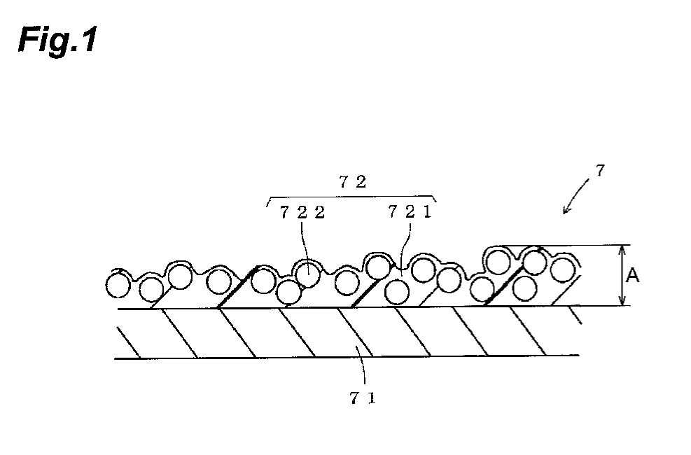

FIG. 1 shows a schematic diagram illustrating an embodiment of the optical film according to the present invention. The optical film 7 in FIG. 1 is formed by laminating an anti-glare layer 72 on one surface of a substrate film 71 wherein the anti-glare layer 72 is prepared by dispersing and mixing translucent fine particles 722 in a translucent resin 721.

It is important that the translucent fine particles 722 used herein have an average particle size of 0.5 μm or more and less than 5 μm, and the blending amount of the translucent fine particles 722 in the translucent resin 721 is 35 parts by weight or more and 60 parts by weight or less in relation to 100 parts by weight of the translucent resin. By setting the average particle size and the blending amount of the translucent resin 722 so as to fall within the above-described ranges, the degradation of the display quality is suppressed at wide view angles without causing the degradation of the front contrast, and the occurrence of scintillation is also impeded. A high transmission image definition is also obtained. The more preferable average particle size of the translucent fine particles 722 is 2 to 5 μm, and the more preferable blending amount of the translucent fine particles 722 is 40 to 50 parts by weight.

As the translucent fine particles 722 used in the present invention, heretofore known fine particles can be used without any particular limitation as long as the translucent fine particles have the above-described average particle size and translucency. Examples of such translucent fine particles include organic fine particles such as an acrylic resin, a melamine resin, polyethylene, polystyrene, an organic silicone resin, a acryl-styrene copolymer, and the like, and inorganic fine particles such as calcium carbonate, silica, aluminum oxide, barium carbonate, barium sulfate, titanium oxide, glass and the like; one of these is used or two or more of these are used as mixtures. Balloons of organic polymers and glass hollow beads can also be used. The shape of the translucent fine particles may be any shape such as a spherical shape, a flat shape, a plate-like shape and a needle-like shape; particularly preferable is a spherical shape.

The refractive index of the translucent fine particles 722 is preferably set to be larger than the refractive index of the translucent resin 721; the difference between these refractive indexes is preferably in a range from 0.04 to 0.1. By setting the difference between the refractive index of the translucent fine particles 722 and the refractive index of the translucent resin 721 so as to fall within the above-described range, the light incident on the anti-glare layer 72 can undergo not only the development of the surface scattering due to the asperities of the anti-glare layer surface but the development of the internal scattering due to the refractive index difference between the translucent fine particles 722 and the translucent resin 721, and hence the occurrence of scintillation can be suppressed. It is preferable that the refractive index difference is 0.1 or less, since when the refractive index difference is 0.1 or less, the whitening of the optical film 7 tends to be suppressed.

As the translucent resin 721 used in the present invention, such resins that have translucency can be used without any particular limitation; examples of such usable resins include: ionizing radiation curable resins such as ultraviolet curable resins and electron beam curable resins; thermocurable resins; thermoplastic resins; and metal alkoxides. Among these, preferred are the ionizing radiation curable resins from the viewpoint that the ionizing radiation curable resins have a high hardness and impart a sufficient scratch resistance to the optical film disposed on the display surface.

Examples of the ionizing radiation curable resin include multifunctional acrylates such as the acrylic acid esters or the methacrylic acid esters of polyhydric alcohols, multifunctional urethane acrylates such as synthesized from a diisocyanate, a polyhydric alcohol and a hydroxyester of an acrylic acid or methacrylic acid; and the like. In addition to these, polyether resin, polyester resin, epoxy resin, alkyd resin, spiroacetal resin, polybutadiene resin, polythiol-polyene resin having acrylate based functional groups, and the like can also be used.

When of the ionizing radiation curable resins, an ultraviolet curable resin is used, a photopolymerization initiator is added. Any photopolymerization initiator may be used, and it is preferable to use a photopolymerization initiator suitable for the resin used. As the photopolymerization initiator (radical polymerization initiator), benzoin and the alkyl ethers of benzoin such as benzoin, benzoin methyl ether, benzoin ethyl ether, benzoin isopropyl ether and benzyl methyl ketal are used. The used amount of the photosensitizer is 0.5 to 20 wt % and is preferably 1 to 5 wt % in relation to the resin.

Examples of the thermocurable resin include a thermocurable urethane resin made of an acrylic polyol and an isocyanate prepolymer, a phenolic resin, a urea-melamine resin, an epoxy resin, an unsaturated polyester resin and a silicone resin.

As the thermoplastic resin, cellulose derivatives such as acetyl cellulose, nitrocellulose, acetyl butyl cellulose, ethyl cellulose and methyl cellulose; vinyl resins such as vinyl acetate and the copolymers thereof, vinyl chloride and the copolymers thereof, vinylidene chloride and the copolymers thereof; acetal resins such as polyvinyl formal and polyvinyl butyral; acryl-based resins such as acrylic resins and the copolymers thereof and methacrylic resins and the copolymers thereof; polystyrene resin, polyamide resin, linear polyester resin, polycarbonate resin and the like; can be used.

As the metal alkoxide, a silicon oxide based matrix made from a silicon alkoxide based material as a raw material can be used. Specific examples of the metal alkoxide include tetramethoxysilane and tetraethoxysilane, and from them, inorganic matrices or organic inorganic composite matrices can be formed by hydrolysis and dehydration condensation.

When an ionizing radiation curable resin is used as the translucent resin 721, it is necessary to irradiate the applied resin with an ionizing radiation such as ultraviolet light or an electron beam after the ionizing radiation curable resin is applied to the substrate film 71 and dried. When a thermocurable resin or a metal alkoxide is used as the translucent resin 721, heating is required after application and drying, as the case may be.

In present Description, the term “the layer thickness of the anti-glare layer” means the maximum thickness between the surface of the anti-glare layer in contact with the substrate film and the opposite surface of the anti-glare layer. Accordingly, when the anti-glare layer has asperities in the optical film of the present invention, the thickest portion corresponding to A shown in FIG. 1 defines the layer thickness of the anti-glare layer. It is important that the layer thickness A of the anti-glare layer 72 is one or more and three or less times the average particle size of the translucent fine particles 722. When the layer thickness A of the anti-glare layer 72 is less than one times the average particle size of the translucent fine particles 722, the texture of the obtained optical film 7 becomes coarse, and at the same time scintillation tends to occur to degrade the visibility of the display screen. On the other hand, when the layer thickness A of the anti-glare layer 72 exceeds three times the average particle size of the translucent fine particles 722, it is difficult to form asperities on the surface of the anti-glare layer 72. The layer thickness A of the anti-glare layer 72 is preferably in a range from 5 to 25 μm. When the layer thickness A of the anti-glare layer 72 is less than 5 μm, no scratch resistance sufficient for the anti-glare layer 72 to be disposed on the display surface may be obtained, and on the other hand, when the layer thickness A of the anti-glare layer 72 exceeds 25 μm, the curling degree of the prepared optical film 7 may come to be large to degrade the handleability. In the portions in which the thickness between the surface of the anti-glare layer in contact with the substrate film and the opposite surface of the anti-glare layer is not maximal (for example, the recessed portions of the film having asperities), the thickness of the anti-glare layer may be less than one times the average particle size of the translucent fine particles 722.

The substrate film 71 used in the present invention is only required to be translucent; as the substrate film 71, for example, glass or plastic films can be used. Such plastic films are only required to have a moderate transparency and a moderate mechanical strength. Examples thereof include cellulose acetate based resins such as TAC (triacetyl cellulose), acrylic resins, polycarbonate resins and polyester based resins such as polyethylene terephthalate.

The optical film 7 of the present invention is prepared, for example, as follows. The substrate film 71 is coated with a resin solution in which the translucent fine particles 722 are dispersed, the coating film thickness is regulated so as for the translucent fine particles 722 to appear on the coating film surface, and thus fine asperities are formed on the substrate surface. In this case, the dispersion of the translucent fine particles 722 is preferably an isotropic dispersion.

For the purpose of improving the coatability, of improving the adhesion with the anti-glare layer and the like, the substrate film 71 may be subjected to a surface treatment before the application of the resin solution. Specific examples of the surface treatment include a corona discharge treatment, a glow discharge treatment, an acid treatment, an alkali treatment and an ultraviolet light irradiation treatment.

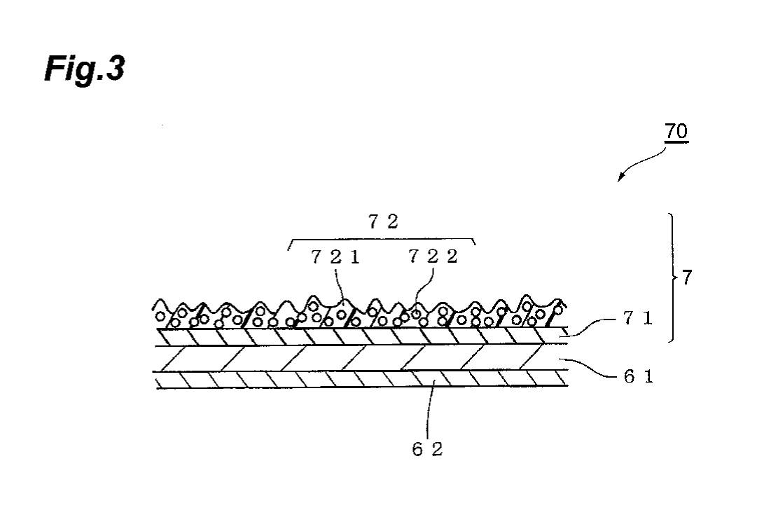

When the optical film 7 of the present invention is used as a supporting film of a below-described polarizing plate (shown in FIG. 3), from the viewpoint of effectively bonding the substrate film 71 and a polarizer 61 (shown in FIG. 3) to each other, it is preferable to subject the substrate film 71 to a hydrophilization treatment through an acid treatment or an alkali treatment.

The method for applying the resin solution to the substrate film 71 is not limited, and for example, a gravure coating method, a microgravure coating method, a roll coating method, a rod coating method, a knife coating method, an air knife coating method, a kiss coating method, a die coating method the following methods and the like, can be used.

After the resin solution is applied to the substrate film 71 directly or through the intermediary of another layer, the solvent is dried by heating if necessary. Next, the coating film is cured with ionizing radiation and/or heat. The type of the ionizing radiation in the present invention is not particularly limited; depending on the type of the translucent resin 721, the ionizing radiation can be appropriately selected from ultraviolet light, electron beam, near ultraviolet light, visible light, near infrared light, infrared light, X-ray and the like; ultraviolet light and electron beam are preferable, and ultraviolet light is particularly preferable because the handling thereof is easy and simple and high energy is easily obtained.

As the light source of the ultraviolet light for photopolymerizing an ultraviolet curable compound, any light source generating ultraviolet light can be used. For example, a low-pressure mercury lamp, a medium-pressure mercury lamp, a high-pressure mercury lamp, an ultra-high-pressure mercury lamp, a carbon arc lamp, a metal halide lamp, a xenon lamp and the like can be used. An ArF excimer laser, a KrF excimer laser, an excimer lamp or synchrotron radiation or the like can also be used. Among these, the ultra-high-pressure mercury lamp, the high-pressure mercury lamp, the low-pressure mercury lamp, the carbon arc, the xenon arc and the metal halide lamp can be preferably used.

Similarly, the electron beam can also be used as the ionizing radiation for curing the coating film. Examples of the electron beam include the electron beams having an energy of 50 to 1000 keV and preferably 100 to 300 keV, emitted from various electron beam accelerators such as a Cockroft-Walton type accelerator, a Van de Graaf type accelerator, a resonance transformer type accelerator, an insulated core transformer type accelerator, a linear type accelerator, a Dynamitron type accelerator and a high-frequency type accelerator.

For the purpose of continuously producing the optical film 7 of the present invention, the following steps are required: a step of continuously letting out the substrate film 71 wound in a roll shape, a step of applying and drying the resin solution, a step of curing the coated film and a step of taking up the optical film 7 in which the cured anti-glare layer 72 is formed.

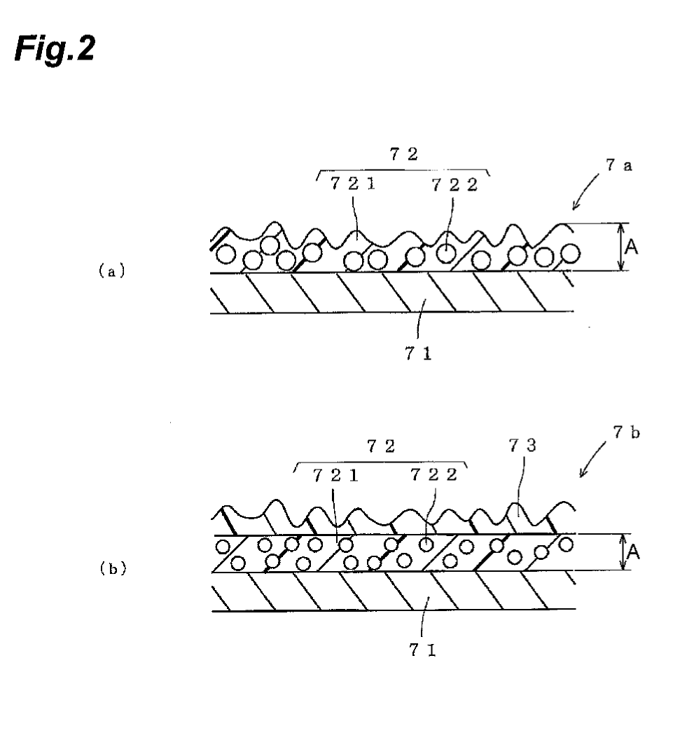

Other embodiments of the optical film of the present invention are shown in FIG. 2. The optical film 7a shown in FIG. 2(a) is formed by laminating, on one surface of a substrate film 71, an anti-glare layer 72 prepared by dispersing and mixing translucent fine particles 722 in a translucent resin 721, and fine asperities are formed on the surface of the anti-glare layer 72 by sand blast or the like. For the purpose of forming the fine asperities on the surface of the anti-glare layer 72, there may be used a method in which the anti-glare layer 72 is surface processed by sand blast processing, emboss shaping processing or the like or a method in which by using a casting mold having a mold surface provided with reversed asperities or an emboss roll, fine asperities are formed in the step of preparing the anti-glare layer 72. The optical film 7b shown in FIG. 2(b) is formed by laminating a translucent resin layer 73, having fine asperities formed on the surface thereof, on an anti-glare layer 72 provided by dispersing and mixing translucent fine particles 722 in a translucent resin 721. In the case of FIG. 2(a), the layer thickness A of the anti-glare layer is the maximum thickness between the surface of the anti-glare layer in contact with the substrate film and the opposite surface having the asperities formed thereon. In the case of FIG. 2(b), the layer thickness A of the anti-glare layer is the maximum thickness between the surface of the anti-glare layer in contact with the substrate film and the opposite surface in contact with the translucent resin layer 73.

Successively, with reference to FIG. 3, a laminated film 70 using the above-described optical film 7 is described. The polarizing plate usually has a structure in which a supporting film 62 is bonded onto the both sides of a polarizer 61. The laminated film 70 shown in FIG. 3 uses the optical film 7 as one of the supporting films of the polarizer 61 of the polarizing plate, and is a multifunctional film having a polarizing function and an anti-glare function. That is, the supporting film 62 is bonded to one surface of the polarizer 61 and the optical film 7, prepared by forming on the substrate film 71 the anti-glare layer 72 having fine asperities formed on the surface thereof, is bonded to the other surface of the polarizer 61. When the laminated film 70 having such a configuration and functioning as a polarizing plate is fixed to a liquid crystal display device, the laminated film 70 is bonded to the glass substrate or the like of the liquid crystal display panel so as for the optical film 7 to be placed on the light-exiting side. The supporting film 71 and the polarizer 61 may be bonded to each other through the intermediary of an adhesive layer, but is preferably bonded to each other directly without the intermediary of any adhesive layer.

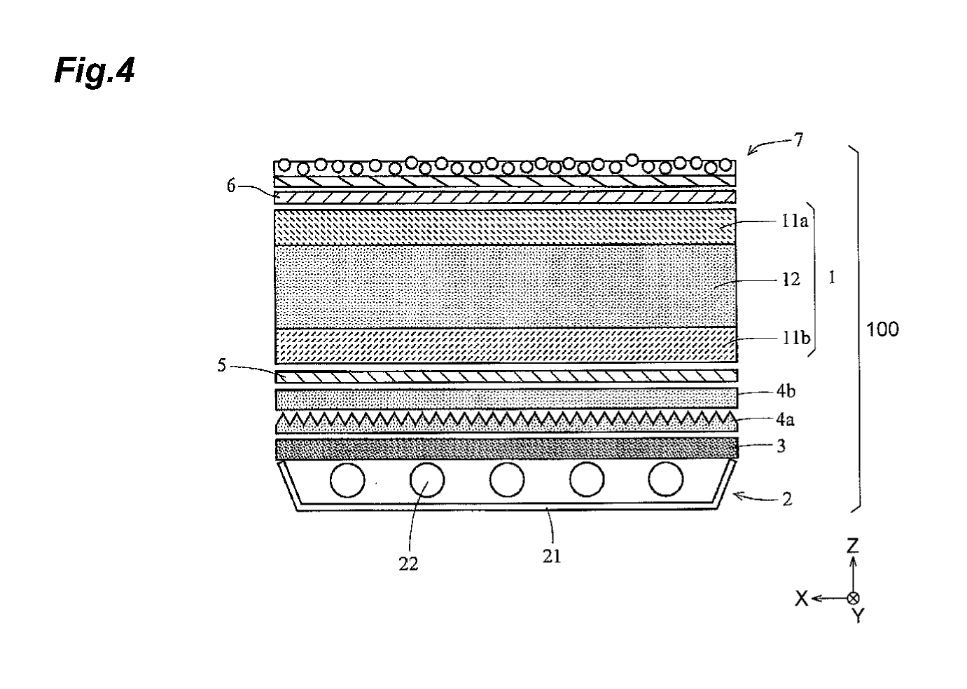

Next, the liquid crystal display device according to the present invention is described. FIG. 4 shows a schematic diagram illustrating an example of the liquid crystal display device 100 according to the present invention. The liquid crystal display device of FIG. 4 is a TN-mode liquid crystal display device of normally white mode, provided by arranging a backlight device 2, a light diffusing plate 3, two sheets of prism films 4a and 4b as the light deflecting means, a first polarizing plate 5, a liquid crystal cell 1 having a liquid crystal layer 12 provided between a pair of transparent substrates 11a and 11b, a second polarizing plate 6 and an optical film 7, in this order. The perpendicular line of the light-exiting surface of the light diffusing plate 3 is set to be approximately parallel to the Z-axis. When the light diffusing plate 3 is not provided, the perpendicular line of the light-exiting surface (opening section) of the backlight 2 is set to be approximately parallel to the Z-axis. Furthermore, the perpendicular line of the light incident surface of the prism films 4a and 4b is set to be approximately parallel to the Z-axis.

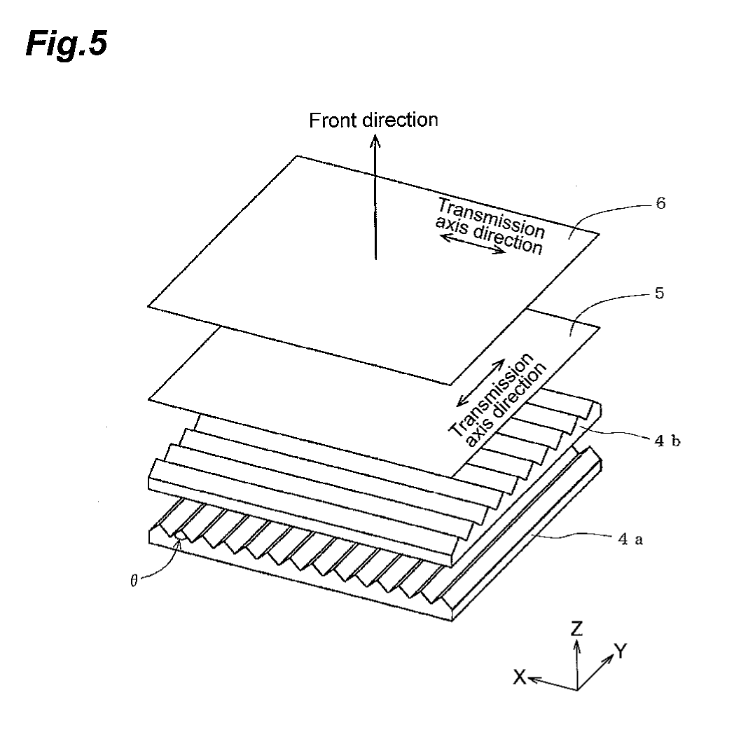

As shown in FIG. 5, the first polarizing plate 5 and the second polarizing plate 6 are arranged such that the transmission axes thereof (Y-direction and X-direction) are in crossed Nicol relation. Each of the two sheets of the prism films 4a and 4b has a flat light incident surface and a plurality of linear prisms having a triangle cross-section shape formed in parallel on the light-exiting surface. The prism film 4a is arranged such that the ridge lines of the linear prisms are approximately parallel to the transmission axis direction of the first polarizing plate 5; the prism film 4b is arranged such that the ridge lines of the linear prisms are approximately parallel to the transmission axis direction of the second polarizing plate 6. The vertex angle θ of the linear prisms having a triangle cross-section shape is in a range from 90° to 110°. The triangle cross-section shape is optionally equilateral or inequilateral. For the purpose of condensing light in the front direction, however, an isosceles triangle is preferable. A configuration is preferred in which an adjacent isosceles triangle is sequentially arrayed adjacent to a base facing to a vertex angle, and ridge lines, which are rows of vertex angles, foam long axes so as to be provided approximately parallel to each other. In this case, as long as the light condensing capability is not remarkably degraded, the vertexes and the base angles may have a curvature. The distances between the ridge lines are normally in a range from 10 μm to 500 μm and preferably in a range from 30 μm to 200 μm. When viewed from the light-exiting surface side, the ridge lines of the linear prisms may be either straight lines or undulate curves. In present Description, when the ridge lines are undulate curves as viewed from the light-exiting surface side, the direction of the ridge lines mean the direction of a regression line obtained by a least-square method.

When the liquid crystal display device is designed to be of normally black mode, it is only required to arrange the first polarizing plate 5 and the second polarizing plate 6 such that the transmission axis direction of the first polarizing plate 5 and the transmission axis direction of the second polarizing plate 6 are parallel to each other.

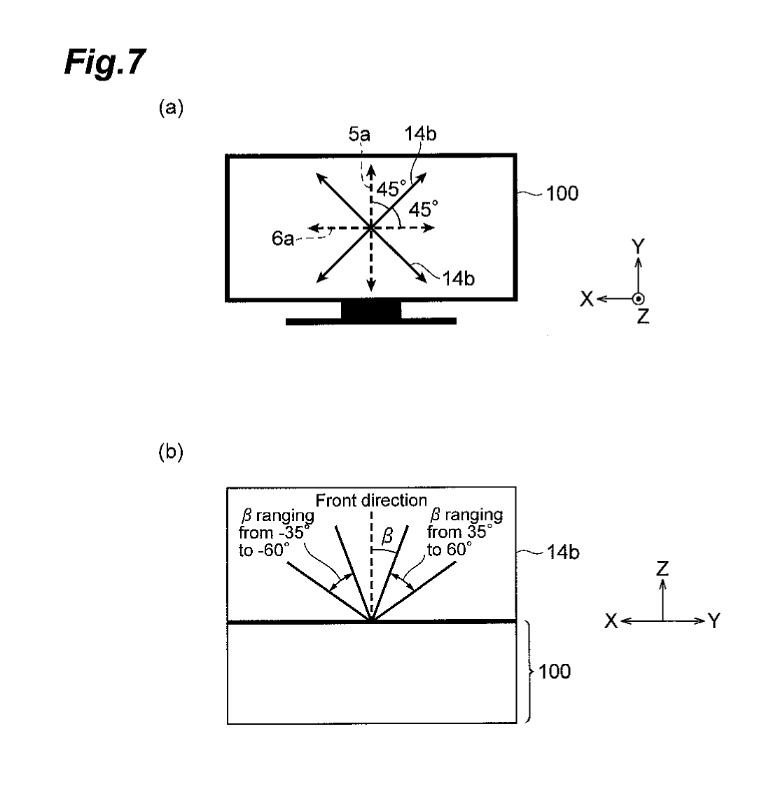

In the liquid crystal display device 100 having such a configuration, as shown in FIG. 4, the light radiated from the backlight device 2 is diffused by a light diffusing plate 3, then enters the prism film 4a. In a perpendicular cross section (ZX plane) orthogonal to the transmission axis of the first polarizing plate 5, the light obliquely entering the lower surface of the prism film 4a exits after its path is diverted to the front direction. Subsequently, in a perpendicular cross section (ZY plane) orthogonal to the transmission axis of the second polarizing plate 6 in the prism film 4b, the light obliquely entering the lower surface of the prism film 4b exits after its path is diverted to the front direction, similar to above. Accordingly, the light passing through the two prism films 4a and 4b is condensed in the front direction (Z direction) in the both perpendicular cross sections, and the luminance in the front direction is enhanced. As shown in FIGS. 7(a) and (b), in a plane 14b parallel to the direction forming an angle of approximately 45° to the transmission axis 5a of the first polarizing plate 5 and the transmission axis 6a of the second polarizing plate 6, and parallel to the front direction (Z-direction), the luminance is decreased in a direction largely inclining relative to the front direction (Z direction), for instance, directions having an angle β defined by the front direction (Z direction) ranging from +35° to +60° and from −35° to −60°. Thus, in the provided liquid crystal display device 100, “light leakage of black state” is thus reduced in the directions of approximately 45° from the transmission axes of the polarizing plates. The term “light leakage of black state” herein means a whitening phenomenon in black display.

Then, going back to FIG. 4, the light to which the directionality in the front direction is given is converted from circularly polarized light into linearly polarized light by the first polarizing plate 5, and then enters the liquid crystal cell 1. The light entering the liquid crystal cell 1, whose polarization plane is controlled for every pixel by the orientation of the liquid crystal layer 12 controlled by an electric field, exits from the liquid crystal cell 1. Then, the light exiting from the liquid crystal cell 1 is converted into image by the second polarizing plate 6, exits through the optical film 7 to the display screen side.

As described above, in the liquid crystal display device 100 of the present invention, the directionality, in the front direction, of the light incident on the liquid crystal cell 1 is higher than conventional due to the two sheets of the prism films 4a and 4b. Accordingly, the front direction luminance is improved as compared to conventional devices, and at the same time, in the liquid crystal display device 100, the light leakage of black state is reduced in the directions of 45° from the transmission axes of the polarizing plates. Because the above-described optical film 7 is also used, without the degradation of the front contrast, the occurrence of the failure of the display quality at wide view angles is impeded, a high transmission image definition is obtained, and further, the occurrence of scintillation is impeded.

Each member of the liquid crystal display device according to the present invention is explained below. First, the liquid crystal cell 1 used in the present invention in FIG. 1 is provided with the pair of transparent substrates 11a and 11b and the liquid crystal layer 12, the transparent substrates 11a and 11b being oppositely arranged at a predetermined distance by a spacer not shown in the drawing, the liquid crystal layer 12 being composed of a liquid crystal encapsulated between the pair of transparent substrates 11a and 11b. Although not shown in the drawing, the pair of transparent substrates 11a and 11b is each provided with a transparent electrode and an oriented film, which are laminated. Applying a voltage based on display data between the transparent electrodes orients the liquid crystal. The display type of the liquid crystal cell 1 herein is TN, but a display type such as IPS and VA may be employed.

The backlight device 2 is provided with a rectangular parallelepiped case 21 having an opening on an upper surface and a plurality of cold-cathode tubes 22 arranged in the case 21 as a linear light source. The case 21 is formed of a resin material or a metal material. In view of reflection of the light emitted from the cold-cathode tubes 22 by the internal peripheral surface of the case, it is preferred that at least the internal peripheral surface of the case have a white color or a silver color. In addition to the cold-cathode tubes, hot-cathode tubes or linearly disposed LEDs may be used as the light source. In the case where the linear light source is used, there is no particular limit to the number of arranged linear light sources. In view of prevention of luminance unevenness of a luminescent surface, however, it is preferred that the distance between the centers of adjacent linear light sources be within a range of 15 and 150 mm. The backlight device 2 used in the present invention is not limited to a direct under type shown in FIG. 4. A conventionally known type, such as a side-light type or a planar light source type, may be used, the side-light type having a linear light source or a point light source disposed on a side surface of a light guide plate, the planar light source type having a light source itself having a flat surface shape.

The light diffusing plate 3 is composed of a base material mixed with a dispersed diffusing agent. Examples of the base material to be used polycarbonates; methacrylate resins; methyl methacrylate-styrene copolymer resins; acrylonitrile-styrene copolymer resins; methacrylate-styrene copolymer resins; polystyrenes; polyvinyl chlorides; polyolefins such as polypropylene and polymethylpentene; cyclic polyolefins; polyester resins such as polyethylene terephthalate, polybutylene terephthalate, and polyethylene naphthalate; polyamide resins; polyarylates; and polyimides. The diffusing agent dispersed into the base material is fine particles composed of a material having a refractive index different from that of the base material. Examples of such a diffusing agent include organic fine particles different from the base material, such as acrylic resins, melamine resins, polyethylenes, polystyrenes, organic silicone resins, and acrylic-styrene copolymers; and inorganic fine particles, such as calcium carbonate, silica, aluminum oxide, barium carbonate, barium sulfate, titanium oxide, and glass. One type from the materials is used, or two or more types from the materials are used as a mixture. Furthermore, organic polymer balloons or glass hollow beads may be used as a diffusing agent. It is preferred that the average particle size of the diffusing agent be within a range of 0.5 μm and 30 μm. The shape of the diffusing agent may not only be spherical, but also be flat, platy, or acicular. The liquid crystal display device of the present invention is not required to include a light diffusing means such as the light diffusing plate 3, but is preferably provided with a light diffusing means.

In the prism films 4a and 4b, the light incident surface side is a flat plane, and a plurality of linear prisms having a triangle cross-sectional shape are formed in parallel on the light-exiting surface side. Examples of the material for the prism films 4a and 4b include polycarbonate resins, ABS resins, methacrylate resins, methyl methacrylate-styrene copolymer resins, polystyrene resins, acrylonitrile-styrene copolymer resins, and polyolefin resins, such as polyethylene and polypropylene. A regular molding process of thermoplastic resin may be employed as a method of producing the prism film. For example, production may be performed in hot-press molding using a mold. A diffusing agent may be dispersed in the prism films 4a and 4b. The thickness of the prism films 4a and 4b is normally 0.1 to 15 mm, preferably 0.5 to 10 mm.

The light diffusing plate 3 and the prism films 4a and 4b may be integrally molded, or may be independently prepared and then bonded to each other. An air layer may also be provided between the light diffusing plate 3 and the prism films 4a and 4b.

The first polarizing plate 5 and the second polarizing plate 6 generally used in the present invention are each composed of a polarizer having support films bonded on two surfaces thereof. Examples of the polarizer include a polarizer substrate in which an adsorbed dichroic dye or iodine is oriented, the polarizer substrate being composed of a polyvinyl alcohol resin, a polyvinyl acetate resin, an ethylene/vinyl acetate (EVA) resin, an polyamide resin, or a polyester resin; and a polyvinyl alcohol/polyvinylene copolymer containing an oriented molecular chain of a dichroic dehydrated product of polyvinyl alcohol, i.e. polyvinylene, in a molecularly-oriented polyvinyl alcohol film. In particular, a polarizer substrate made of polyvinyl alcohol resin in which an adsorbed dichroic dye or iodine is oriented is suitably used as the polarizer. There is no particular limit to the thickness of the polarizer. For the purpose of thinning of the polarizing plate, however, a thickness of 100 μm or less is generally preferable, more preferably a range of 10 to 50 μm, and most preferably a range of 25 to 35 μm.

As the support film that supports and protects the polarizer, a film is preferred which is composed of a polymer having low birefringence and being excellent in transparency, mechanical strength, thermal stability, and waterproof performance. Such a film may be prepared by processing a resin, for example, a cellulose acetate resin, such as TAC (triacetylcellulose); an acrylic resin; a fluorinated resin, such as a tetrafluoroethylene/hexafluoropropylene copolymer; a polycarbonate resin; a polyester resin, such as polyethylene terephthalate; a polyimide resin; a polysulfone resin; a polyether sulfone resin; a polystyrene resin; a polyvinyl alcohol resin; a polyvinyl chloride resin; a polyolefin resin; or a polyamide resin, into a film. Among these materials, a triacetylcellulose film or a norbornene thermoplastic resin film having a surface saponified with alkaline or the like is preferably used in view of a polarization property and durability. The norbornene thermoplastic resin film is suitably used in particular, since the film serves as an excellent barrier against heat and humidity, thus significantly improving the durability of the polarizing plate; and has low moisture absorption, thus significantly enhancing stability in dimensions. Molding and processing into a film shape can be performed by a conventionally known process, such as a casting method, a calendar method, or an extrusion method. There is no limit to the thickness of the support film. In view of thinning of the polarizing plate, however, a thickness of 500 μm or less is normally preferable, more preferably a range of 5 to 300 μm, and furthermore preferably a range of 5 to 150 μm.

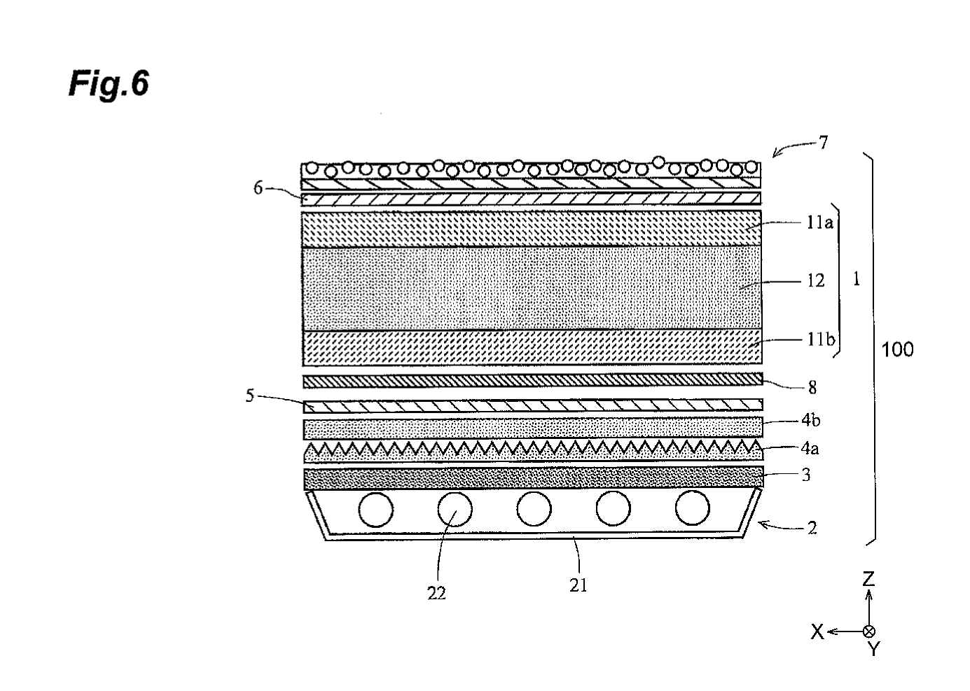

An alternative embodiment of a liquid crystal display device 100 according to the present invention is illustrated in FIG. 6. The liquid crystal display device 100 in FIG. 6 is different from the liquid crystal display device 100 in FIG. 4 in that a retardation film 8 is arranged between the first polarizing plate 5 and the liquid crystal cell 1. The retardation film 8 substantially has no phase difference in the perpendicular direction to the surface of the liquid crystal cell 1, and has no optical effect from the front, but exhibits a phase difference from an oblique view, thus compensating for the phase difference generated in the liquid crystal cell 1. Thereby, more excellent display quality and color reproducibility are achieved in a wider view angle. The retardation film 8 may be arranged either or both between the first polarizing plate 5 and the liquid crystal cell 1 or/and between the second light diffusing layer 6 and the liquid crystal cell 1.

Examples of the retardation film 8 include a polycarbonate resin or cyclic olefin copolymer resin formed into a film which is then a biaxially-stretched, and a liquid crystal monomer undergoing photopolymerization reaction to fix its molecular arrangement. The retardation film 8, which is used for optical compensation of the liquid crystal arrangement, is composed of a material having a refractive index characteristic opposite to the liquid crystal arrangement. Specifically, for example, a “WV Film” (manufactured by Fujifilm Corporation) is preferably used for a TN-mode liquid crystal display cell; an “LC Film” (manufactured by Nippon Oil Corporation) for an STN-mode liquid crystal display cell; a biaxial retardation film for an IPS-mode liquid crystal cell; a retardation plate combining an A plate and a C plate, or a biaxial retardation film for a VA-mode liquid crystal cell; and an “OCB WV Film” (manufactured by Fujifilm Corporation) for a π cell mode liquid crystal cell.

### EXAMPLES

Hereinafter, the present invention is described in more detail on the basis of Examples, but the present invention is not limited to these Examples in any way.

### Optical Film Preparation Example 1

### (1) Preparation of Mold for Embossing

An iron roll (JIS STKM13A) of 200 mm in diameter the surface of which was subjected to copper ballard plating was prepared. The copper ballard plating was composed of a cooper plating layer/a thin silver plating layer/a surface copper plating layer, and the thickness of the whole plating layers was approximately 200 μm. The surface of the copper plating layer was subjected to mirror polishing, further the polished surface was blasted by using a blasting apparatus (manufactured by Fuji Manufacturing Co., Ltd) with the zirconia beads TZ-B 125 (average particle size: 125 μm, manufactured by Tosoh Corp.) as the first fine particles, under the conditions that the blast pressure was 0.05 MPa (the gauge pressure, as is also the case for what follows) and the used amount of the fine particles was 16 g/cm² (the used amount per 1 cm² of the surface area of the roll, as is also the case in what follows), and thus asperities were formed on the surface. The surface having asperities was blasted by using the blasting apparatus (manufactured by Fuji Seisakusho K.K.) with the zirconia beads TZ-SX-17 (average particle size: 20 μm, manufactured by Tosoh Corp.) as the second fine particles, under the conditions that the blast pressure was 0.1 MPa and the used amount of the fine particles was 4 g/cm², and thus the surface asperities were finely regulated. The obtained copper-plated iron roll with asperities was subjected to an etching treatment with a cupric chloride solution. In this etching, the etching magnitude was set to be 3 μm. Then, a chromium plating processing was performed to prepare a mold. In this case, the thickness of the chromium plating was set to be 4 μm. The Vickers hardness of the chromium plating surface of the obtained mold was 1000. The Vickers hardness was measured by using an ultrasonic hardness meter MIC10 (Krautkramer Corp.) in accordance with JIS Z 2244 (in the following examples, the method for measuring the Vickers hardness is the same).

### (2) Preparation Example 1 of Optical Film Having Anti-Glare Layer and Substrate Film

Pentaerythritol triacrylate (60 parts by mass) and a multifunctional urethanated acrylate (a reaction product between hexamethylene diisocyanate and pentaerythritol triacrylate, 40 parts by mass) were mixed in an ethyl acetate solution, the resulting solution was regulated so as to have a solid content concentration of 60%, and thus an ultraviolet curable resin composition was obtained. The refractive index of the cured product obtained by ultraviolet curing after removing ethyl acetate from the composition was found to be 1.53.

Next, to 100 parts by mass of the solid content of the ultraviolet curable resin composition, 40 parts by mass of polystyrene based particles (manufactured by Sekisui Plastics Co., Ltd.) having an average particle size of 2.0 μm as translucent fine particles and 5 parts by mass of “Lucirin TPO” (chemical name: 2,4,6-trimethylbenzoyl diphenyl phosphine oxide, manufactured by BASF Ltd.) serving as a photopolymerization initiator were added; the resulting mixture was diluted with ethyl acetate so as for the solid content to be 50%, and thus a coating solution was prepared. The coating solution was applied onto an 80-μm thick triacetyl cellulose (TAC) film (substrate film) and was dried for 1 minute in a dryer set at 80° C. The substrate film having been dried was closely attached onto the surface with asperities of the mold prepared in the above-described (1), by pressing the substrate film against the mold with a rubber roll so as for the ultraviolet curable resin composition layer to face the mold. Under this condition, from the substrate film side, irradiation with the light from a high-pressure mercury lamp at an intensity of 20 mW/cm² was performed such that the irradiation light intensity was 300 mJ/cm² in terms of the light intensity at the h-line, thus the ultraviolet curable resin composition layer was cured, and consequently the optical film composed of the anti-glare layer having asperities on the surface thereof and the substrate film, and having the structure shown in FIG. 2(a) was obtained. The haze value was measured with a haze computer (HGM-2DP, manufactured by Suga Test Instruments Co., Ltd.) in accordance with JIS-K-7105. The result thus obtained is shown in Table 1.

### Optical Film Preparation Example 2

An optical film was prepared in the same manner as in the Optical Film Preparation Example 1 except that 40 parts by mass of polystyrene based particles (manufactured by Soken Chemicals & Engineering Co., Ltd.) having an average particle size of 3.0 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

### Optical Film Preparation Example 3

An optical film was prepared in the same manner as in the Optical Film Preparation Example 1 except that 40 parts by mass of polystyrene based particles (manufactured by Sekisui Plastics Co., Ltd.) having an average particle size of 4.0 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

### Optical Film Preparation Example 4

An optical film was prepared in the same manner as in the Optical Film Preparation Example 1 except that 50 parts by mass of polystyrene based particles (manufactured by Sekisui Plastics Co., Ltd.) having an average particle size of 2.0 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

### Optical Film Preparation Example 5

An optical film was prepared in the same manner as in the Optical Film Preparation Example 1 except that 60 parts by mass of polystyrene based particles (manufactured by Soken Chemicals & Engineering Co., Ltd.) having an average particle size of 3.0 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

### Optical Film Preparation Example 6

An optical film was prepared in the same manner as in the Optical Film Preparation Example 1 except that 30 parts by mass of polystyrene based particles (manufactured by Sekisui Plastics Co., Ltd.) having an average particle size of 4.0 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

### Optical Film Preparation Example 7

An optical film was prepared in the same manner as in the Optical Film Preparation Example 1 except that 80 parts by mass of polystyrene based particles (manufactured by Soken Chemicals & Engineering Co., Ltd.) having an average particle size of 3.0 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

### Optical Film Preparation Example 8

An optical film was prepared in the same manner as in the Optical Film Preparation Example 1 except that 30 parts by mass of silicone resin based particles (manufactured by Momentive Performance Materials Inc.) having an average particle size of 4.5 μm were used in place of 40 parts by mass of polystyrene based particles (manufactured by Sekisui Plastics Co., Ltd.) having an average particle size of 2.0 μm used in the Optical Film Preparation Example 1, and the haze value of the obtained optical film was measured. The result thus obtained is shown in Table 1.

TABLE 1

| | | | | Refractive index | | |
|---|---|---|---|---|---|---|
| | Translucent fine particles | | | difference | Thickness | |
| | Average | | Blending | between | of | |
| | particle | | amount | translucent fine | anti-glare | Haze |
| | size | Refractive | (parts by | particles and | layer | value |
| | (μm) | index | mass)*¹ | translucent resin | (μm) | (%) |
| Preparation | 2.0 | 1.59 | 40 | 0.06 | 5.2 | 47.6 |
| Example 1 | | | | | | |
| Preparation | 3.0 | 1.59 | 40 | 0.06 | 4.7 | 47.7 |
| Example 2 | | | | | | |
| Preparation | 4.0 | 1.59 | 40 | 0.06 | 6.1 | 36.2 |
| Example 3 | | | | | | |
| Preparation | 2.0 | 1.59 | 50 | 0.06 | 5.7 | 50.1 |
| Example 4 | | | | | | |
| Preparation | 3.0 | 1.59 | 60 | 0.06 | 3.9 | 45.7 |
| Example 5 | | | | | | |
| Preparation | 4.0 | 1.59 | 30 | 0.06 | 6.4 | 32.9 |
| Example 6 | | | | | | |
| Preparation | 3.0 | 1.59 | 80 | 0.06 | 5.7 | 48.2 |
| Example 7 | | | | | | |
| Preparation | 4.5 | 1.43 | 30 | −0.10 | 4.4 | 49.2 |
| Example 8 | | | | | | |

*¹The used amount (parts by mass) in relation to 100 parts by mass of the solid content of the ultraviolet curable resin composition.

[Evaluation of the Transmission Image Definition of the Optical Films of Preparation Examples 1 to 8]

For each of the optical films of Preparation Examples 1 to 8, the transmission image definition was evaluated as follows. By using an optically transparent adhesive, the substrate film of the optical film was bonded to a glass substrate to prepare a measurement sample. By such bonding, the warpage of the film at the time of measurement is prevented, and the measurement reproducibility can be enhanced. As the measurement apparatus, an image clarity tester “ICM-1DP” (manufactured by Suga Test Instruments Co., Ltd.) in accordance with HS K 7105 was used. In accordance with HS K 7105, for each of the optical films, the sum of the transmission image definitions obtained through optical combs was calculated, wherein the width ratio between the dark sections and the bright sections in each of the combs is 1:1, and the widths are 0.125 mm, 0.5 mm, 1.0 mm and 2.0 mm, respectively. The maximum value of the transmission image definition is 400%. The case where the transmission image definition is 70% or more is satisfactory in the transmission image definition and is marked with ◯. The case where the transmission image definition is less than 70% is poor in the transmission image definition and is marked with X. The results thus obtained are shown in Table 2.

TABLE 2

| Optical film | Transmission image definition |
|---|---|
| Preparation Example 1 | ◯ |
| Preparation Example 2 | ◯ |
| Preparation Example 3 | ◯ |
| Preparation Example 4 | ◯ |
| Preparation Example 5 | ◯ |
| Preparation Example 6 | ◯ |
| Preparation Example 7 | X |
| Preparation Example 8 | ◯ |

The transmission image definition is an evaluation of the degree of blurring of an image. The optical films of the present invention (Preparation Examples 1 to 5) and the optical films of Preparation Example 6 and Preparation Example 8 were satisfactory in the transmission image definition. The optical film of Preparation Example 7 was low in the transmission image definition.

### Light Diffusing Plate Preparation Example

By using a Henschel mixer, 74.5 parts by mass of a styrene-(methyl methacrylate) copolymer resin (refractive index: 1.57), 25 parts by mass of crosslinked poly(methyl methacrylate) resin particles (refractive index: 1.49, weight-average particle size: 30 μm), 0.5 part by mass of a benzotriazole based ultraviolet absorber (“Sumisorb 200,” manufactured by Sumitomo Chemical Co., Ltd.) and 0.2 part by mass of a hindered phenol based antioxidant (thermostabilizer) (“IRGANOX 1010,” manufactured by Ciba Specialty Chemicals Inc.) were mixed together, then were melt-kneaded with a second extruder, and the resulting mixture was fed to a feed block.

On the other hand, by using a Henschel mixer, 99.5 parts by mass of a styrene resin (refractive index: 1.59), 0.07 part by mass of the benzotriazole based ultraviolet absorber (“Sumisorb 200,” manufactured by Sumitomo Chemical Co., Ltd.) and 0.13 part by mass of a light stabilizer (“Tinuvin 770,” manufactured by Ciba Specialty Chemicals Inc.) were mixed together, then the resulting mixture was melt-kneaded with crosslinked siloxane based resin particles (“Trefil DY33-719,” manufactured by Dow Corning Toray Silicone Co., Ltd., refractive index: 1.42, weight-average particle size: 2 μm) with a first extruder, and the resulting mixture was fed to a feed block. By regulating the addition amount of the crosslinked siloxane based resin particles, the total light transmittance Tt was regulated, and thus a light diffusing plate having a total light transmittance Tt of 65% was prepared.

The light diffusing plate was a 2-mm thick laminated plate composed of three layers (a 1.90-mm thick intermediate layer and two 0.05-mm thick surface layers) formed by performing coextrusion molding such that the resin fed to the feed block from the first extruder formed the intermediate layer (base layer) and the resin fed to the feed block from the second extruder formed the surface layers (the both sides of the surface). The total light transmittance Tt was measured by using a haze transmittance meter (HR-100, manufactured by Murakami Color Research Laboratory Co., Ltd.) in accordance with JIS K 7361.

### Prism Film Preparation Example

A 1-mm thick flat plate was prepared by press molding a styrene resin (refractive index: 1.59) with a mold having a mirror-finished surface. The surface condition of the obtained flat plate was measured according to JIS B0601-1994, and the Ra (mean center line roughness) was found to be 0.01 μm and the Rz (ten-point mean height) was found to be 0.08 μm. Furthermore, a metal mold was used to press-mold the styrene resin plate again, the metal mold being provided with parallel V-shaped linear grooves having an isosceles triangular cross section of a vertex angle θ and a distance between ridge lines of 50 μm. Thereby, a prism film was produced. Three prism films were prepared herein having vertex angels θ of 90°, 95°, and 110°, respectively, and were used together with the light diffusing plate prepared as described above in below-described Examples and Reference Examples.

### Examples 1 to 5 and Reference Examples 1 to 3

### Production of Liquid Crystal Display Devices

The prism films having the vertex angle θ of 95° and the light diffusing plate were respectively placed in the backlight device of the IPS-mode 32-inch liquid crystal television set “Wooo UT32-HV700B” manufactured by Hitachi, Ltd. As shown in FIG. 5, two sheets of the prism films placed in the liquid crystal display device were arranged such that the ridge line directions of the linear prisms thereof are orthogonal. Then, the polarizing plates on the light-exiting side of the liquid crystal cell were peeled off, and Iodine-based regular polarizing plates “TRW842AP7” manufactured by Sumitomo Chemical Co., Ltd. were bonded so as to be a crossed Nicol wherein the bonding was performed such that the transmission axes of the polarizing plates were respectively parallel to the short side and the long side of the liquid crystal cell. The arrangement of the prism films and the polarizing plates was the same as in FIG. 5. On that, the optical film prepared in the above-described preparation example was bonded, and thus a liquid crystal display device was produced.

### Examples 1 to 5 and Reference Examples 1 to 3

### Evaluation of the Front Contrasts of Liquid Crystal Display Devices

The front contrast of each of the produced liquid crystal display devices was measured as follows. In a dark room, by using a luminance meter BM-5A (manufactured by Topcon Technohouse Corp.), the front luminance values of the liquid crystal display device in the black display mode and the white display mode were measured, and the front contrast was calculated. The front contrasts of the produced liquid crystal display devices were measured. The results thus obtained are shown in Table 3.

TABLE 3

| | Optical film | Front contrast |
|---|---|---|
| Example 1 | Preparation Example 1 | 2072 |
| Example 2 | Preparation Example 2 | 2178 |
| Example 3 | Preparation Example 3 | 2132 |
| Example 4 | Preparation Example 4 | 2030 |
| Example 5 | Preparation Example 5 | 2006 |
| Reference Example 1 | Preparation Example 6 | 2213 |
| Reference Example 2 | Preparation Example 7 | 1753 |
| Reference Example 3 | Preparation Example 8 | 1694 |

As is seen from Table 3, the liquid crystal display devices of Examples 1 to 5 and Reference Example 1 are excellent in front contrast, but the liquid crystal display devices of Reference Example 2 and 3 are poor in front contrast.

### Examples 1 to 5 and Reference Example 1

### Evaluation of the View Angles of Liquid Crystal Display Devices

Of the produced liquid crystal display devices, the liquid crystal display devices of Examples 1 to 5 and Reference Example 1 excellent in front contrast were subjected to a visual evaluation of the display qualities at predetermined view angles. As the display qualities, the occurrence/nonoccurrence of the gradation irregularity and the occurrence/nonoccurrence of the gradation reversal were examined. The results thus obtained are shown in Table 4.

TABLE 4

| | | View angle | | |
|---|---|---|---|---|
| | Optical film | 40° | 50° | 60° |
| Example 1 | Preparation Example 1 | ⊚ | ⊚ | ⊚ |
| Example 2 | Preparation Example 2 | ⊚ | ⊚ | ⊚ |
| Example 3 | Preparation Example 3 | ⊚ | ⊚ | ⊚ |
| Example 4 | Preparation Example 4 | ⊚ | ⊚ | ⊚ |
| Example 5 | Preparation Example 5 | ⊚ | ⊚ | ⊚ |
| Reference Example 1 | Preparation Example 6 | Δ | X | X |

⊚: Absolutely no abnormalities are found in the display qualities.
◯: A slight degree of gradation irregularity is found, but almost no display quality abnormalities other than this are found.
Δ: The gradation irregularity is found, but the displayed image is visible.
X: The gradation irregularity and the gradation reversal are found.

As is seen from Table 4, in the liquid crystal display devices of Examples 1 to 5, neither the gradation irregularity nor the gradation reversal is found at the view angles of 40° to 60°, and absolutely no abnormalities are found in the display qualities, but in the liquid crystal display device of Reference Example 1, the gradation irregularity and the gradation reversal are found at the view angles of 50° or more, and hence the display qualities are poor. The view angle as referred to herein means the angle corresponding to the exiting angle β on the flat plane 14b in FIG. 7(b). No scintillation occurred in the liquid crystal display devices of Examples 1 to 5, but scintillation occurred in the liquid crystal display device of Reference Example 1.

### Examples 6 to 10 and Reference Example 4

### Evaluation of the View Angles of Liquid Crystal Display Devices

A liquid crystal display device was produced in the same manner as in Examples 1 to 5 and Reference Example 1 except that the prism films having a vertex angle θ of 110° and the light diffusing plate were placed in place of the prism films having a vertex angle θ of 95° and the light diffusing plate used in Examples 1 to 5 and Reference Example 1, and a visual evaluation of the display qualities at predetermined view angles were performed. As the display qualities, the occurrence/nonoccurrence of the gradation irregularity and the occurrence/nonoccurrence of the gradation reversal were examined. The results thus obtained are shown in Table 5.

TABLE 5

| | | View angle | | |
|---|---|---|---|---|
| | Optical film | 40° | 50° | 60° |
| Example 6 | Preparation Example 1 | ⊚ | ⊚ | ◯ |
| Example 7 | Preparation Example 2 | ⊚ | ⊚ | ◯ |
| Example 8 | Preparation Example 3 | ⊚ | ⊚ | ◯ |
| Example 9 | Preparation Example 4 | ⊚ | ⊚ | ◯ |
| Example 10 | Preparation Example 5 | ⊚ | ⊚ | ◯ |
| Reference Example 4 | Preparation Example 6 | Δ | X | X |

⊚: Absolutely no abnormalities are found in the display qualities.
◯: A slight degree of gradation irregularity is found, but almost no display quality abnormalities other than this are found.
Δ: The gradation irregularity is found, but the displayed image is visible.
X: The gradation irregularity and the gradation reversal are found.

As is seen from Table 5, in the liquid crystal display devices of Examples 6 to 10, almost no abnormalities are found in the display qualities, but in the liquid crystal display device of Reference Example 4, the gradation irregularity and the gradation reversal are found at the view angles of 50° or more, and hence the display qualities are poor. No scintillation occurred in the liquid crystal display devices of Examples 6 to 10, but scintillation occurred in the liquid crystal display device of Reference Example 4.

### Examples 11 to 15 and Reference Example 5

### Evaluation of the View Angles of Liquid Crystal Display Devices

A liquid crystal display device was produced in the same manner as in Examples 1 to 5 and Reference Example 1 except that the prism films having a vertex angle θ of 90° and the light diffusing plate were placed in place of the prism films having a vertex angle θ of 95° and the light diffusing plate used in Examples 1 to 5 and Reference Example 1, and a visual evaluation of the display qualities at predetermined view angles were performed. As the display qualities, the occurrence/nonoccurrence of the gradation irregularity and the occurrence/nonoccurrence of the gradation reversal were examined. The results thus obtained are shown in Table 6.

TABLE 6

| | | View angle | | |
|---|---|---|---|---|
| | Optical film | 40° | 50° | 60° |
| Example 11 | Preparation Example 1 | ⊚ | ⊚ | ◯ |
| Example 12 | Preparation Example 2 | ⊚ | ⊚ | ◯ |
| Example 13 | Preparation Example 3 | ⊚ | ⊚ | ◯ |
| Example 14 | Preparation Example 4 | ⊚ | ⊚ | ◯ |
| Example 15 | Preparation Example 5 | ⊚ | ⊚ | ◯ |
| Reference Example 5 | Preparation Example 6 | Δ | X | X |

⊚: Absolutely no abnormalities are found in the display qualities.
◯: A slight degree of gradation irregularity is found, but almost no display quality abnormalities other than this are found.
Δ: The gradation irregularity is found, but the displayed image is visible.
X: The gradation irregularity and the gradation reversal are found.

As is seen from Table 6, in the liquid crystal display devices of Examples 11 to 15, almost no abnormalities are found in the display qualities, but in the liquid crystal display device of Reference Example 5, the gradation irregularity and the gradation reversal are found at the view angles of 50° or more, and hence the display qualities are poor. No scintillation occurred in the liquid crystal display devices of Examples 11 to 15, but scintillation occurred in the liquid crystal display device of Reference Example 5.

### INDUSTRIAL APPLICABILITY

The liquid crystal display devices including the optical film of the present invention impede the occurrence of the failure of the display quality at wide view angles, are high in the front contrast and the transmission image definition, and impedes the occurrence of scintillation.

### REFERENCE SIGNS LIST

1 Liquid crystal cell
2 Backlight device
3 Light diffusing plate (light diffusing means)
4a, 4b Prism film (light deflecting means)
5 First polarizing plate
6 Second polarizing plate
7 Optical film
8 Retardation plate
71 Substrate film
72 Anti-glare layer
721 Translucent resin
722 Translucent fine particle

1. An optical film comprising:
a substrate film; and
an anti-glare layer in which translucent fine particles are dispersed and mixed in a translucent resin,
wherein an average particle size of the translucent fine particles is 0.5 μm or more and less than 5 μm,
a content of the translucent fine particles is 35 parts by weight or more and 60 parts by weight or less in relation to 100 parts by weight of the translucent resin, and
a layer thickness of the anti-glare layer is one or more and three or less times the average particle size of the translucent fine particles.

2. The optical film according to claim 1, wherein a refractive index of the translucent fine particles is larger than a refractive index of the translucent resin.

3. The optical film according to claim 2, wherein a difference between the refractive index of the translucent fine particles and the refractive index of the translucent resin is 0.04 or more and 0.1 or less.

4. A liquid crystal display device, comprising, in sequence:
a backlight device;
a light deflecting means;
a first polarizing plate;
a liquid crystal cell having a liquid crystal layer provided between a pair of substrates;
a second polarizing plate; and
an optical film,
wherein the first polarizing plate and the second polarizing plate are arranged such that transmission axes thereof are in crossed Nicol relation, and
the optical film is the optical film according to claim 1.

5. The liquid crystal display device according to claim 4,
wherein the light deflecting means has two sheets of prism films provided on a light-exiting surface with a plurality of linear prisms having a polygonal and tapered cross-section and an endmost vertex angle of 90 to 110° at predetermined intervals, and
one of the prism films is arranged such that ridge line directions of the linear prisms thereof are approximately parallel to the transmission axis of the first polarizing plate, and the other prism film is arranged such that ridge line directions of the linear prisms thereof are approximately parallel to the transmission axis of the second polarizing plate.

6. The liquid crystal display device according to claim 5, wherein a light diffusing means is further arranged between the backlight device and the light deflecting means.
